(19) United States
(12) Patent Application Publication
(10) Pub. No.: US 2021/0138854 A1
(43) Pub. Date: May 13, 2021

(54) ANTI FALL-OFF CABLE CHAIN

(71) Applicant: DEQING GENERAL INDUSTRY CO., LTD., Zhejiang (CN)

(72) Inventor: Quanhua LU, Zhejiang (CN)

(73) Assignee: DEQING GENERAL INDUSTRY CO., LTD., Zhejiang (CN)

(21) Appl. No.: 16/493,304

(22) PCT Filed: Aug. 31, 2016
(86) PCT No.: PCT/CN2016/097595

§ 371 Date: Sep. 12, 2019

(51) Int. Cl. B60C 27/10; B60C 27/06

(52) U.S. Cl. CPC B60C 27/10; B60C 27/067

(57) ABSTRACT

An anti fall-off cable chain includes two side ropes, a transition chains and connecting pieces, wherein the two side ropes are arranged horizontally, the transition chains are longitudinally arranged between the two side ropes, and the side ropes and the transition chains are connected through the connecting pieces. Each connecting piece includes an attaching part to be attached to a side face of a tire, a side rope mounting part arranged at one end of the attaching part, and a transition chain mounting part arranged at another end of the attaching part. When pulled by the part, attached to the tread of the tire, of the transition chain to tilt upwards, the transition chain connecting pieces trend to draw away from the mounting holes and are limited by first upper limiting parts.

### FIELD OF THE INVENTION

The invention relates to antiskid devices which are applied to the tires of vehicles to improve the traction on roads covered with ice or snow, in particular to an anti fall-off cable chain capable of greatly improving the connection strength between side ropes and a transition chain.

### DESCRIPTION OF RELATED ART

Chinese Invention Patent Authorized Publication No. CN1017130B discloses a slanted tire chain which is provided with side ropes and a transition chain connected with the side ropes through buckles shown in FIG. 1.

When the slanted tire chain is assembled on a tire, the buckles are disposed on side faces of the tire, the transition chain extends across the tread of the tire to be connected with the buckles on the side faces of the tire; after the transition chain extends across the tread of the tire, the two sides of the transition chain are bent downwards to be connected with the buckles, and at this moment, buckle beads at the two ends of the transition chain are stressed to tilt upwards. In the using process of the tire chain, the buckle beads and slots will be worn and deformed under the interaction between the buckle beads and the buckles, and the wear of the peripheries of the buckle beads and mounting holes is particularly severe; and when the buckle beads and the slots are worn and deformed to a certain degree, the buckle beads which should be kept tilting upwards to abut against the mounting holes in use may be pulled out of the buckles from above via the mounting holes, and consequentially, the transition chain disengages from the buckles and hits the vehicle, which in turn causes damage to the vehicle.

### BRIEF SUMMARY OF THE INVENTION

In view of the above technical problems, the invention provides an anti fall-off cable chain capable of guaranteeing the high connection strength between side ropes and a transition chain.

The anti fall-off cable chain comprises two side ropes, a transition chain, and connecting pieces, wherein the two side ropes are arranged horizontally, the transition chain is longitudinally arranged between the two side ropes, and the side ropes and the transition chain are connected through the connecting pieces. Each connecting piece comprises an attaching part to be attached to the side face of a tire, a side rope mounting part arranged on the inner side of the attaching part, and a transition chain mounting part arranged on the outer side of the attaching part. The transition chain comprises transition chain connecting pieces arranged at the ends of the transition chain and matched with the connecting pieces, and an antiskid piece arranged between the transition chain connecting pieces. The transition chain mounting part is formed by upward bending and inward bending of the connecting piece from the attaching part and includes a first upper limiting part having a projection on the attaching part and a first side limiting part having a projection on the outer side of the attaching part, wherein the attaching part is provided with at least one mounting hole which is narrowed down to form a slot at least extending to the second side limiting part from the attaching part. Each transition chain connecting piece includes a first limiting part which penetrates through one mounting hole to be limited between the attaching part and the transition chain mounting part.

The mounting holes are formed in the attaching parts to be attached to the side wall of the tire and are blocked by the side wall of the tire after the cable chain is assembled on the tire. When pulled by the part, attached to the tread of the tire, of the transition chain, the transition chain connecting pieces which tilt upwards to trend to draw away from the mounting holes are limited by the first upper limiting parts, so that the situation that the first limiting parts are pulled to be separated from the connecting pieces via the mounting holes is effectively prevented; and it is guaranteed that the transition chain and the connecting pieces are connected more firmly when the transition chain is pulled with a greater force, and the connection strength and reliability of the side ropes and the transition chain are greatly improved.

Preferably, each mounting hole is partially covered with the projection of the first upper limiting part on the attaching part.

Preferably, the end of the first limiting part stretches out of the inner side of the first upper limiting part.

Preferably, each transition chain connecting piece further includes a second limiting part and a connecting column, wherein the second limiting part is located at the other end of the transition chain connecting piece, and the connecting column penetrates through the first side limiting part via the slot to connect the first limiting part and the second limiting part together.

Preferably, each transition chain connecting piece has a circular cross-section.

Preferably, the side rope mounting part is formed by upward bending and outward bending of the connecting piece from the attaching part and includes a second upper limiting part having a projection on the attaching part and a second side limiting part having a projection on the inner side of the attaching part.

Preferably, an interval is reserved between the projection of the first upper limiting part on the attaching part and the projection of the second upper limiting part on the attaching part, and the mounting hole is partially located at the interval on the attaching part.

Preferably, each connecting piece is integrally formed by a metal plate through stamping.

By means of improvements on the connecting pieces of the prior art, the anti fall-off cable chain fundamentally solves the technical problem that the transition chain may be separated from the connecting pieces in the prior art, and the connection strength between the side ropes and the transition chain is improved; and the anti fall-off cable chain is simple in structure, convenient to assemble, and low in cost, and improvements on the side ropes and the transition chain in the prior art are not needed.

### BRIEF DESCRIPTION OF THE DRAWINGS

FIG. 1 is a connection diagram of a buckle in the prior art.

FIG. 2 is a schematic diagram of a cable chain in an unfolded state.

FIG. 3 is an assembly diagram of the cable chain and a tire.

FIG. 4 is a connection diagram of a transition chain and connecting pieces.

FIG. 5 is a structural diagram of the transition chain.

FIG. 6 is a top view of the connecting piece.

FIG. 7 is a side view of the connecting piece.

FIG. 8 is a schematic diagram of the connecting piece in an unfolded state.

FIG. 9 is a schematic diagram of a transition chain connecting piece in an unfolded state.

### DETAILED DESCRIPTION OF THE INVENTION

The implementation of the invention is expounded below in combination with the accompanying drawings.

As shown in FIG. 2, an anti fall-off cable chain comprises two side ropes 1 which are arranged horizontally and a transition chain 2 which is longitudinally arranged between the two side ropes in a Z shape, wherein the side ropes 1 and the transition chain 2 are connected through connecting pieces 3. Each connecting piece 3 comprises an attaching part 31 to be attached to the side face of a tire, a side rope mounting part 32 arranged on the inner side of the attaching part 31, and a transition chain mounting part 33 arranged on the outer side of the attaching part 31. In this embodiment, “inner side” refers to a side away from the center of the tire, and “outer side” refers to a side close to the center of the tire.

The transition chain 2 comprises a steel wire rope, a steel plate-coiled cable or a steel wire-coiled spring disposed around the steel wire rope, and transition chain connecting pieces 21 arranged at two ends of the steel wire rope. The transition chain 2 and the connecting pieces 3 are connected together through the cooperation between the transition chain connecting pieces 21 and the transition chain mounting parts 33.

As shown in FIG. 6, the transition chain mounting part 33 is formed by upward bending and inward bending of the connecting piece 3 from the attaching part 31 and includes a first upper limiting part 332 having a projection on the attaching part 31 and a first side limiting part 333 having a projection on the outer side of the attaching part 31. The attaching part 31 is provided with mounting holes 331 which are narrowed down to form slots 334 extending to the first side limiting part 333 from the attaching part 31 and then extending to the first upper limiting part 332 from the first side limiting part 333. In this embodiment, “upper” refers to a direction away from the side wall of the tire, and “lower” refers to a direction pointing to or close to the side wall of the tire. A limiting structure having a U-shaped cross-section is formed by the first upper limiting part 332 and the attaching part 31 which are arranged vertically, and the first side limiting part 333 arranged on the outer side of the attaching part 31.

Each transition chain connecting piece 21 comprises a thick first limiting part 211, a thick second limiting part 212, and a thin connecting column 213, wherein the first limiting part 211 and the second limiting part 212 are located at two ends of the transition chain connecting piece 21 and are connected through the connecting column 213; and the first limiting part 211 is located at one end of the transition chain, and compared with the first limiting part 211, the second limiting part 212 is closer to the middle of the transition chain 2. The diameter of the mounting holes 331 should be large enough, so that the first limiting part 211 can penetrate through the mounting holes 331. The slots 334 formed by narrowing down the mounting holes 331 are larger than the connecting column 213 and small than the first limiting part 211, so that the thick first limiting part 211 cannot penetrate through the slots 334, while the thin connecting column 231 can penetrate through the slots 334 and can move in the slots 334.

The side rope mounting part 32 is formed by upward bending and outward bending of the connecting piece 3 from the attaching part 31 and includes a second upper limiting part 321 having a projection on the attaching part 31 and a second side limiting part 322 having a projection on the inner side of the attaching part 31, wherein a limiting structure having a U-shaped side face is formed by the attaching part 31, the second upper limiting part 321, and the second side limiting part 322 arranged at the end of the attaching part 31.

A steel plate is stamped and punched to form a semi-finished product, shown in FIG. 8, of the connecting piece 3, and then the two ends of the steel plate are bent upwards and then bent towards the middle to form the structure shown in FIG. 7. Afterwards, one side rope 1 is placed in the U-shaped limiting structure formed by the second upper limiting part 321 and the second side limiting part 322 of the side rope mounting part 32, and the attaching part 31, and then the second upper limiting part 321 is pressed towards the attaching part 31 to limit the side rope 1 between the attaching part 31 and the side rope mounting part 32.

Afterwards, the transition chain 2 and the connecting piece 3 are connected in such a manner: the first limiting part 211 of the transition chain connecting piece 21 penetrates through one mounting hole 331 from the attaching part 31 with the connecting column 213 in the corresponding slot 334, and then extends to the first side limiting part 333 from the attaching part 31 to be limited in the U-shaped limiting structure formed by the attaching part 31, the first upper limiting part 332 and the first side limiting part 333, and then the first upper limiting part 332 is pressed towards the attaching part 31 to limit the first limiting part 211 between the attaching part 31 and the transition chain mounting part 33. At this moment, the first limiting part 211 is located on the inner side of the first side limiting part 333, the second limiting part 212 is located on the outer side of the first side limiting part 333, the connecting column 213 penetrates through one slot 334 to connect the first limiting part 211 and the second limiting part 212 together, and in this way, the transition chain 3 and the connecting piece 2 are connected.

In order to realize firmer connection between the transition chain 2 and the connecting piece 3 and to reduce the wear, the mounting holes 331 are partially covered by the projection of the first upper limiting part 332 on the attaching part 31, and the end of the first limiting part 211 stretches out of the inner side of the first upper limiting part 332. Each transition chain connecting piece 21 is metal buckle bead having a circular cross-section, and a metal plate is stamped to form a planar structure shown in FIG. 9 and is then pressed on the steel wire rope.

In order to facilitate installation, an interval is reserved between the projection of the first upper limiting part 332 on the attaching part 31 and the projection of the second upper limiting part 321 on the attaching part 31, and at least two thirds of each mounting hole 321 is located at the interval on the attaching part 31.

Although the implementation of the invention is described in combination with the accompanying drawings, various transformations or modifications can be achieved by those ordinarily skilled in the art within the scope of the appended claims.

1. An anti fall-off cable chain, comprising two side ropes, a transition chain and connecting pieces, wherein the two side ropes are arranged horizontally, the transition chain is longitudinally arranged between the two side ropes, and the side ropes and the transition chain are connected through the connecting pieces; each of the connecting pieces comprises an attaching part to be attached to a side face of a tire, a side rope mounting part arranged at an end of the attaching part, and a transition chain mounting part arranged at an end of the attaching part; the transition chain comprises transition chain connecting pieces arranged at ends of the transition chain and matched with the connecting pieces, and an antiskid piece arranged between the transition chain connecting pieces; wherein the transition chain mounting part is formed by upward bending and inward bending of each of the connecting pieces from the attaching part and includes a first upper limiting part having a projection on the attaching part and a first side limiting part having a projection on an outer side of the attaching part; the attaching part is provided with mounting holes; each of the mounting holes is narrowed down to form a slot at least extending to the first side limiting part from the attaching part; each of the transition chain connecting pieces includes a first limiting part which penetrates through one of the mounting holes and is limited between the attaching part and the transition chain mounting part; and the mounting holes are attached to the side face of the tire, so that the first limiting parts of the transition chain connecting pieces are prevented from being separated from the connecting pieces via the mounting holes, which causes damage to a vehicle due to continuous hitting to a vehicle body from the transition chain rotating along with the tire.

2. The anti fall-off cable chain according to claim 1, wherein each of the mounting holes is partially covered with the projection of the first upper limiting part on the attaching part.

3. The anti fall-off cable chain according to claim 2, wherein an end of the first limiting part stretches out of an inner side of the first upper limiting part.

4. The anti fall-off cable chain according to claim 1, wherein each of the transition chain connecting pieces further comprises a second limiting part located on one side of the transition connecting piece and a connecting column penetrating through the first side limiting part via one said slot to connect the first limiting part and the second limiting part together.

5. The anti fall-off cable chain according to claim 1, wherein each of the transition chain connecting pieces has a circular cross-section.

6. The anti fall-off cable chain according to claim 1, wherein the side rope mounting part is formed by upward bending and outward bending of each of the connecting pieces from the attaching part and includes a second upper limiting part having a projection on the attaching part and a second side limiting part having a projection on an outer side of the attaching part.

7. The anti fall-off cable chain according to claim 6, wherein an interval is reserved between the projection of the first upper limiting part on the attaching part and the projection of the second upper limiting part on the attaching part, and each of the mounting hole is partially located at the interval on the attaching part.

8. The anti fall-off cable chain according to claim 1, wherein each of the connecting pieces is integrally formed by a metal plate through stamping.
